(19) United States
(12) Patent Application Publication
(10) Pub. No.: US 2023/0327148 A1
(43) Pub. Date: Oct. 12, 2023

(54) A REINFORCED SEALED FUEL CELL ASSEMBLY

(71) Applicant: Ballard Power Systems Inc., Burnaby (CA)

(72) Inventors: Makoto Adachi, Vancouver (CA); Elisabeth Noyer, Vancouver (CA); Gabriel Yves Fortin, Coquitlam (CA); Johnny Gong, Vancouver (CA)

(21) Appl. No.: 18/297,750

(22) Filed: Apr. 10, 2023

Related U.S. Application Data
(60) Provisional application No. 63/329,702, filed on Apr. 11, 2022.

(51) Int. Cl. H01M 8/0284; H01M 8/2483; H01M 8/1004

(52) U.S. Cl. CPC H01M 8/0284; H01M 8/2483; H01M 8/1004; H01M 2008/1095

(57) ABSTRACT

A sealed fuel cell assembly comprising a sealed active region comprising an ionomer electrolyte disposed between an anode electrode and a cathode electrode to form a membrane electrode assembly; a sealed manifold region adjacent the sealed active area; and an elastomeric seal comprising a first elastomeric seal bead circumscribing a periphery of the membrane electrode assembly and a second elastomeric seal bead circumscribing a periphery of a manifold port; wherein the elastomeric seal further comprises a reinforcing material that is physically separated from the membrane electrode assembly and has a lower elasticity than the elastomeric seal.

### BACKGROUND

### Technical Field

The present invention relates to sealed fuel cell assemblies.

### Description of the Related Art

Fuel cells are devices in which fuel and oxidant fluids electrochemically react to generate electricity. A type of fuel cell being developed for various commercial applications is the solid polymer electrolyte fuel cell, which employs a membrane electrode assembly (MEA) comprising a solid polymer electrolyte made of a suitable ionomer material (e.g., Nafion®) disposed between two electrodes. Each electrode comprises an appropriate catalyst located next to the solid polymer electrolyte. The catalyst may be, for example, a metal black, an alloy, or a supported metal catalyst such as platinum on carbon. The catalyst may be disposed in a catalyst layer, and the catalyst layer typically contains ionomer, which may be similar to that used for the solid polymer electrolyte. A fluid diffusion layer (a porous, electrically conductive sheet material) is typically employed adjacent to the electrode for purposes of mechanical support, current collection, and/or reactant distribution. In the case of gaseous reactants, such a fluid diffusion layer is referred to as a gas diffusion layer. If a catalyst layer is incorporated onto a gas diffusion layer, the unit is referred to as a gas diffusion electrode.

For commercial applications, a plurality of fuel cells are generally stacked in series in order to deliver a greater output voltage. Separator plates are typically employed adjacent the gas diffusion electrode layers in solid polymer electrolyte fuel cells to separate one cell from another in a stack. Fluid distribution features, including inlet and outlet ports, fluid distribution plenums and numerous fluid channels, are typically formed in the surface of the separator plates adjacent the electrodes in order to distribute reactant fluids to, and remove reaction by-products from, the electrodes. Separator plates also provide a path for electrical and thermal conduction, as well as mechanical support and dimensional stability to the MEA.

In an assembled fuel cell, the porous gas diffusion layers in the MEA must be adequately sealed at their periphery and to their adjacent separator plates in order to prevent reactant gases from leaking over to the wrong electrode or to prevent leaks between the reactant gases and the atmosphere surrounding the fuel cell stack. This can be challenging because the MEA is typically a relatively large, thin sheet, and thus a seal may be needed over a significant perimeter, and a fuel cell stack typically involves sealing numerous MEAs. Conventionally then, the design of the MEA edge seal should provide for production in high volume and for reliable, high quality leak tight seals. Various ways of accomplishing this have been suggested in the art.

One prior art sealing method involves the use of a sealing gasket that surrounds the MEA and that can be significantly compressed between the anode and cathode separator plates in order to effect a reliable seal between the MEA and ambient. A seal separating the anode from the cathode can be obtained by impregnating gasket seal material into the edges of the MEA and attaching or integrating these impregnated edges to the surrounding gasket. U.S. Pat. No. 6,057,054 discloses such an embodiment using flush-cut MEAs (in which the edges of the membrane electrolyte, electrodes, and gas diffusion layers are aligned and terminate at the same location, i.e., at the flush cut edge).

Other prior art sealing methods can employ more than one material in the sealing region. For example, U.S. Pat. No. 7,771,885 discloses a MEA-frame assembly is arranged in a mold for injection molding to form a first flow passage arranged so as to extend along the outer periphery of an electrode between the outer periphery of the electrode and the inner periphery of a frame, a second flow passage arranged so as to extend along an inner elastic member between the inner periphery and outer periphery of the frame and a plurality of connecting flow passages which communicate the first flow passage with the second flow passage. An elastic resin is injected into the first flow passage to fill the first flow passage with the elastic resin and to fill the second flow passage with the elastic resin through each of the communicating flow passages, thereby an elastic member which hermetically seals the space between the MEA-frame assembly and the separator is integrally formed. The anode electrode and the cathode electrode are attached and secured to both surfaces of the polymer electrolyte membrane to form MEA (membrane-electrode assembly) in this manner and the MEA-frame assembly in which this MEA is sandwiched and supported by the frame is sandwiched between the pair of separators to form the single cell. However, such a design requires that the membrane extend beyond the anode and cathode electrodes so that the frame can be attached to the membrane, which results in higher cost due to the larger size of the membrane, resulting in wasted material, and difficulties in manufacture as the frame must be attached only to the membrane and not the electrodes.

The fuel cell stack also includes manifolds for delivering reactants to the membrane electrode assemblies and for removing excess reactants and products from the membrane electrode assemblies. In one example, the manifolds may be internal manifolds, for example, in the form of apertures in every fuel cell for receiving and removing each of the reactants and coolants from the fuel cell. One such example is described in U.S. Pat. No. 6,066,409. In another example, the manifolds may be external manifolds, such as that described in U.S. Pat. No. 6,696,193. Each manifold must be sealed to the cell stack assembly to prevent leakage of the reactant gases into the ambient environment. External manifolds are less desirable than internal manifolds because external manifolds are typically more prone to leaks and it is difficult to manage thermal expansion differences between the stack material and the external manifold material.

While many designs have been suggested, there remains a need for further improvement in seal designs for fuel cells.

### BRIEF SUMMARY

In one embodiment, a sealed fuel cell assembly comprises a sealed active region comprising an ionomer electrolyte disposed between an anode electrode and a cathode electrode to form a membrane electrode assembly; a sealed manifold region adjacent the sealed active area, the sealed manifold region; and an elastomeric seal comprising a first elastomeric seal bead circumscribing a periphery of the membrane electrode and a second elastomeric seal bead circumscribing a periphery of a manifold port; wherein the elastomeric seal further comprises a reinforcing material that is physically separated from the membrane electrode assembly and has a lower elasticity than the elastomeric seal.

In some embodiments, the elastomeric seal comprises a web section between the first and second elastomeric seal beads; and the reinforcing material is disposed in the web section.

In further embodiments, the adjacent seal bead section comprises a seal bead protruding perpendicularly from the plane of the sealed active region and has a greater height than the web section; and the reinforcing material does not traverse into the first and second elastomeric seal beads.

These and other aspects of the invention will be evident in view of the attached figures and the following detailed description.

### BRIEF DESCRIPTION OF THE DRAWINGS

FIG. 1 is a planar view of an exemplary sealed membrane electrode assembly.

FIG. 2 is a schematic cross-sectional drawing of the sealed membrane electrode assembly at section A-A in one embodiment.

FIG. 3 is a schematic cross-sectional drawing of the sealed membrane electrode assembly at section A-A in another embodiment.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with fuel cells, fuel cell stacks, and fuel cell systems have not been shown or described in detail to avoid unnecessarily obscuring descriptions of the embodiments of the invention.

Unless the context requires otherwise, throughout the specification and claims which follow, the word “comprise” and variations thereof, such as “comprises” and “comprising” are to be construed in an open, inclusive sense, that is, as “including but not limited to”.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

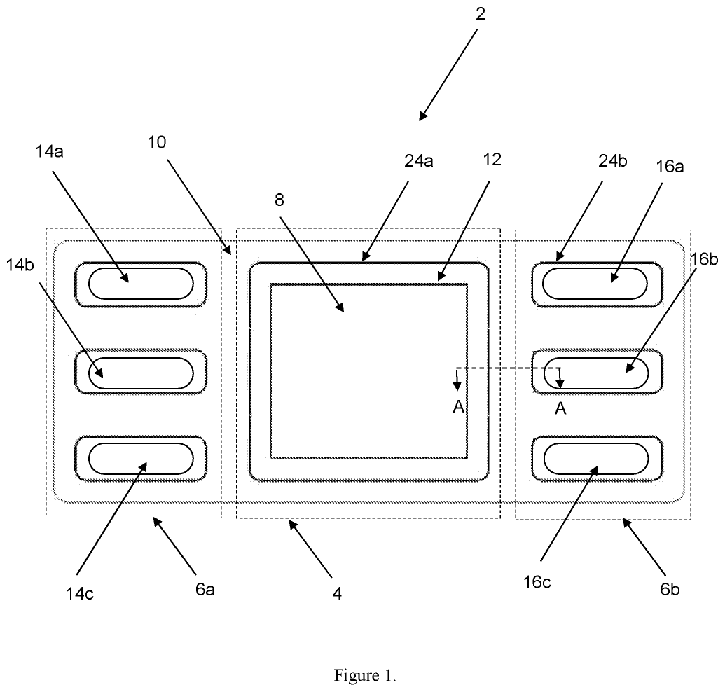

FIG. 1 shows a planar view of a fuel cell assembly 2 comprising an active region 4 and adjacent inlet and outlet manifold regions 6a, 6b. Active region 4 includes a membrane electrode assembly (MEA) 8 with an ionomer electrolyte disposed between an anode electrode and a cathode electrode. An elastomeric seal 10 circumscribes the peripheral edge of MEA 8 at impregnation seal region 12, and impregnates the peripheral edges of the anode and cathode electrodes to substantially seal MEA 8 and prevent reactants from leaking out of the fuel cell stack as well as from crossing over to the other electrode and the coolant. MEA 8 is preferably flush-cut (in other words, the anode electrode, cathode electrode and ionomer electrolyte are substantially the same size) for reasons related to manufacturability and cost reduction.

At manifold regions 6a, 6b, elastomeric seal 10 circumscribes and seals around the periphery of inlet manifold ports 14a, 14b, 14c and outlet manifold ports 16a, 16b, 16c. Inlet manifold ports 14a, 14b, 14c and outlet manifold ports 16a, 16b, 16c are fluidly connected to the flow field plates (not shown) and allow for reactant, product, and coolant fluids to flow into and out of fuel cell assembly 2.

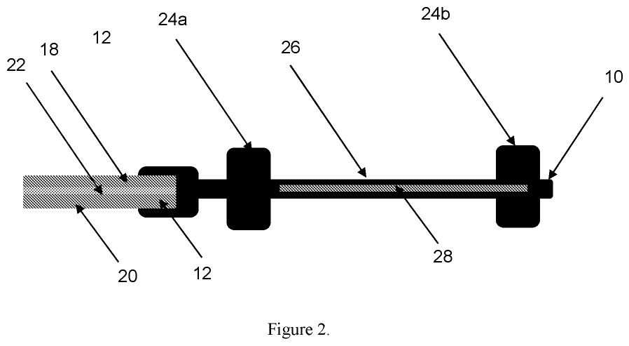

FIG. 2 shows a cross-section of seals of fuel cell assembly 2 at section A-A of FIG. 1. MEA 8 includes an anode electrode 18, cathode electrode 20 and an ionomer electrolyte 22. Elastomeric seal 10 includes MEA impregnation seal region 12, a web section 26 and an adjacent seal bead 24a, 24b. Seal bead 24a circumscribes around MEA 8 and seal bead 24b circumscribes around manifold 16b while web section 26 connects seal beads 24a, 24b. Seal beads 24a, 24b protrude in a direction perpendicular to the planar direction of MEA 8 and are thicker than web section 26. When the fuel cell stack is compressed under a stack compression pressure, seal beads 24a, 24b are compressed against an adjacent flow field plate to form a hermetical seal around the MEA and the manifold ports, thus preventing fluids from leaking into different fluid streams as well as preventing fluids from leaking out of the fuel cell stack.

Elastomeric seal 10 further includes a reinforcing material 28 in at least a portion of web section 26. Reinforcing material 28 preferably has a lower elasticity (as measured by Young's modulus) than the material used for elastomeric seal 10. The inventors have discovered that the relatively high pressure of the fluids travelling through the manifold ports tend to push and displace the elastomeric seal from their desired positions in the planar direction of the fuel cell. This phenomenon may still occur even when the seal bead is contained inside a seal groove of the flow field plate due to the relatively high elasticity of the elastomeric seal material. This displacement of the seal bead leads to an undesirable gas leak at the edge of the fuel cell stack, particularly at the gas outlet side of the fuel cell stack. However, by incorporating a reinforcing material within at least a portion of the elastomeric seal at the outlet manifold region to limit deformation of the elastomeric seal in the planar direction of the fuel cell, the seal bead is better held in position against the flow field plate, thereby reducing the occurrence of gas leaks at the manifold region.

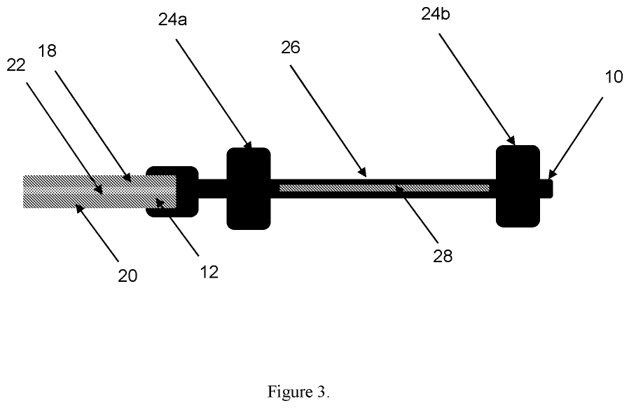

In some embodiments as shown in FIG. 3, reinforcing material 28 does not traverse into the seal bead region because the reinforcing material has a lower elasticity and, therefore, less compressibility, than the seal bead, which may compromise the sealing capability of the elastomeric seal bead when the fuel cell stack is compressed. The reinforcing material is also preferably physically separated from the membrane electrode assembly and all of its components (anode, cathode and ionomer membrane) because so as not to interfere with the sealing function of the elastomeric seal at the peripheral edge of the membrane electrode assembly.

Reinforcing material 28 may be disposed in web section 26 in any area of elastomeric seal 10 and, in some instances, in discrete areas where tensile stresses are largest due to the pressure of the reactants and/or products. For example, with reference to FIG. 1, a reinforcing material may be used along a portion of elastomeric seal 10 in active region 4 and/or along a portion of elastomeric seal 10 at manifold regions 6a, 6b. In other embodiments, reinforcing material may be used throughout the active region and/or manifold region, for example, continuously around the active area and/or around at least one manifold port of the fuel cell. A continuous piece around the manifold port may have the advantage of keeping a seal in place, for example, around the manifold port when the internal fluid pressure increases. One skilled in the art will be able to determine where to use the reinforcing material based on the tensile stresses experienced by the elastomeric seal and ease of manufacturing. In some embodiments, the reinforcement material may allow for the removal of the retaining wall at the edge of the flow field plates that keep the manifold seal bead in place.

The material used for the elastomeric seal may be any material that can withstand the acidic environment of the fuel cell stack. In some embodiments, the elastomeric material is liquid injection moldable such that the seal can be applied to the MEA as well as around the manifold ports in one step, such as that described in U.S. Pat. No. 6,057,054. For example, the elastomeric seal material may be a silicone, ethylene propylene diene terpolymer (EPDM), fluororubbers, perflurorubbers, chloroprene rubbers, fluorosilicone elastomers, polyisobutylate (PIB), ethylene propylene rubber (EPR), and thermoplastic rubbers (TPR). The membrane electrode assembly may be catalytically deactivated at the peripheral seal edge of the anode and/or cathode electrodes to protect the membrane from coming into contact with volatile oxidative species, which formed by the reaction of siloxanes (from silicone-based seal materials) with the catalyst in the electrodes.

The reinforcement material may also be any material that can withstand the acidic environment of the fuel cell stack and be compatible with the elastomeric seal material, but with a lower elasticity (higher Young's modulus) than the elastomeric seal material. For example, the reinforcement material may be a thermoplastic or thermoset. Representative thermoplastics include polyvinylidene fluoride (PVDF), polypropylene, polyethylene, polyolefins, polytetrafluoroethylene (PTFE), and aromatic thermoplastics such as polyaryl ethers, polyether ether ketones (PEEK), polysulfones, etc. Representative thermosets include polyimides, epoxies, polyurethane, nitrile, butyl, thermoplastic elastomers (TPEs), etc. In specific embodiments, the Young's modulus of the reinforcement material is greater than about 100 MPa, and in some embodiments, greater than about 200 MPa. The thickness of the reinforcement material is preferably about 80% or less of the thickness of the web section of the elastomeric seal. For example, the thickness of the reinforcement material is less than about 250 microns.

The flow field plate material may be any suitable material for fuel cell operation, for example, a carbonaceous or metallic material. In some embodiments, the flow field plate may be made from expanded graphite or carbon that is embossed or machined with flow field plate channels, seal grooves and manifold ports. In other embodiments, the flow field plate material may be a metallic, for example, it may be a metal plate coated with a corrosion resistant layer. Fuel cell flow field plates are typically bipolar with anode flow channels on one side and cathode flow channels on the other. Coolant flow channels are formed between the anode flow channel side and the cathode flow channel side. In this situation, two flow field plates are usually glued together, each flow field plate having either anode flow channels or cathode flow channels on one side and coolant flow channels on the other that are glued together such that the coolant flow channel side faces each other.

The reinforcement material may be incorporated in several ways. For example, the reinforcement material may be placed in an injection mold and then the injection moldable seal material is applied on the reinforcement material. In some embodiments, the reinforcement material may comprise perforations to allow for the injection moldable seal material to impregnate therethrough. One skilled in the art will be able to determine a way to incorporate the reinforcement material within the elastomeric seal.

All of the above U.S. patents, U.S. patent application publications, U.S.

patent applications, foreign patents, foreign patent applications and non-patent publications referred to in this specification and/or listed in the Application Data Sheet, are incorporated herein by reference, in their entirety.

While particular elements, embodiments, and applications of the present invention have been shown and described, it will be understood that the invention is not limited thereto since modifications may be made by those skilled in the art without departing from the spirit and scope of the present disclosure, particularly in light of the foregoing teachings.

1. A sealed fuel cell assembly comprising:
a sealed active region comprising an ionomer electrolyte disposed between an anode electrode and a cathode electrode to form a membrane electrode assembly;
a sealed manifold region adjacent the sealed active area; and
an elastomeric seal comprising a first elastomeric seal bead circumscribing a periphery of the membrane electrode assembly and a second elastomeric seal bead circumscribing a periphery of a manifold port;
wherein the elastomeric seal further comprises a reinforcing material that is physically separated from the membrane electrode assembly and has a lower elasticity than the elastomeric seal.

2. The sealed fuel cell assembly of claim 1, wherein the membrane electrode assembly is flush-cut.

3. The sealed fuel cell assembly of claim 1, wherein the elastomeric seal impregnates at least a portion of the anode electrode and the cathode electrode.

4. The sealed fuel cell assembly of claim 1, wherein the elastomeric seal material is selected from the group consisting of silicone, fluorosilicone, fluoroelastomer, ethylene propylene di-methyl, and natural rubber.

5. The sealed fuel cell assembly of claim 1, wherein the reinforcing material comprises a thermoplastic or thermoset material.

6. The sealed fuel cell assembly of claim 1, wherein the reinforcing material has a Young's modulus of greater than about 100 MPa.

7. The sealed fuel cell assembly of claim 1, wherein the reinforcing material comprises at least one perforation.

8. The sealed fuel cell assembly of claim 1, wherein the manifold port is an outlet manifold port.

9. The sealed fuel cell assembly of claim 1, wherein the elastomeric seal comprises a web section between the first and second elastomeric seal beads, wherein the reinforcing material is disposed in the web section.

10. The sealed fuel cell assembly of claim 9, wherein
each elastomeric seal bead protrudes perpendicularly from a plane of the sealed active region and has a greater height than the web section; and
the reinforcing material does not traverse into the first and second elastomeric seal beads.

11. The sealed fuel cell assembly of claim 1 further comprising an inlet manifold region and an outlet manifold region, wherein the reinforcing material is incorporated in at least a portion of the elastomeric seal at the outlet manifold region.
